(19) United States
(12) Patent Application Publication
(10) Pub. No.: US 2024/0375723 A1
(43) Pub. Date: Nov. 14, 2024

(54) FLOOR PANEL

(71) Applicants: Hyundai Motor Company, Seoul (KR); Kia Corporation, Seoul (KR)

(72) Inventors: Seong Su Shin, Seoul (KR); Tae Soo Park, Seoul (KR); Hyun Sik Kim, Seoul (KR)

(21) Appl. No.: 18/356,652

(22) Filed: Jul. 21, 2023

(30) Foreign Application Priority Data
May 9, 2023 (KR) 10-2023-0060111

(51) Int. Cl. B62D 25/20

(52) U.S. Cl. CPC B62D 25/2036

(57) ABSTRACT

An embodiment floor panel includes an embossed forming portion extending in a length direction of the floor panel and an engraved forming portion extending in the length direction of the floor panel, wherein the embossed forming portion and the engraved forming portion are alternately disposed in a width direction of the floor panel.

### CROSS-REFERENCE TO RELATED APPLICATIONS

This application claims the benefit of Korean Patent Application No. 10-2023-0060111, filed on May 9, 2023, which application is hereby incorporated herein by reference.

### TECHNICAL FIELD

Exemplary embodiments of the present disclosure relate to a floor panel.

### BACKGROUND

Referring to FIG. 1, a rear floor panel is positioned at a rear side of a vehicle, constitutes a rear passenger compartment and a trunk space in an upper region, and constitutes a packaging space for a rear wheel motor and an inverter in a lower region.

Among various performances required for the rear floor panel, the most required performance in an electric vehicle is noise, vibration, harshness (NVH) performance of a panel section. Since the rear floor panel should effectively block and distribute noises from a motor, an inverter, and a road noise component in the lower region through securing of rigidity of a floor, the rigidity of the floor is mainly secured through a method of arranging several types of longitudinal members and transverse members in a grid.

The conventional grid arrangement longitudinal and transverse member structure has an advantage of improving the rigidity of the panel by reducing a section of a single panel. However, there are disadvantages such as an increase in the number of parts, an increase in the number of welds, an increase in the complexity of sealer lines, partialization of a transverse member to cause a decrease in torsional rigidity of a vehicle body, and an increase in weight/cost due to the above problems.

The contents described in the above background section are to aid understanding of the background of embodiments of the present disclosure and may include what is not previously known to those skilled in the art to which the present disclosure pertains.

### SUMMARY

Exemplary embodiments of the present disclosure relate to a floor panel. Particular embodiments relate to a rear floor panel mounted below a passenger compartment at a rear side of a vehicle.

An embodiment of the present disclosure provides a floor panel in which a transverse member, which is a main skeletal member of the floor panel, is maintained and all longitudinal members can be omitted.

Other objects and advantages of embodiments of the present disclosure can be understood by the following description and become apparent with reference to the exemplary embodiments of the present disclosure. Also, it is obvious to those skilled in the art to which the present disclosure pertains that the objects and advantages of embodiments of the present disclosure can be realized by the means as claimed and combinations thereof.

In accordance with an embodiment of the present disclosure, there is provided a floor panel in which an embossed forming portion and an engraved forming portion, which are formed in a length direction of the floor panel, are alternately formed in a width direction of the floor panel.

In addition, the embossed forming portion may be formed to more protrude than an imaginary panel neutral line connecting both side ends of the floor panel, and the engraved forming portion may be formed to be more depressed than the panel neutral line.

In addition, the embossed forming portion and the engraved forming portion may each be formed as two or more portions.

Specifically, the floor panel may further include a first forming portion formed in a central portion of the floor panel in a width direction and second forming portions formed to be connected from both side ends of the first forming portion, and the first forming portion and the second forming portions may be alternately formed as the embossed forming portion or the engraved forming portion.

Here, the second forming portions may be symmetrically formed based on the first forming portion.

In addition, a pair of forming portions may be formed to be connected from one side end of each of the second forming portions.

Meanwhile, the floor panel may be a rear floor panel which is mounted below a rear passenger compartment of a vehicle and both end portions of which are coupled to a pair of rear side members, respectively.

In addition, each of a pair of trigger forming portions coupled to each of the pair of rear side members may be formed at both ends of the rear floor panel in the width direction.

Further, each of the trigger forming portions may be coupled to a joggle formed at the rear side member.

In addition, an interval between front end portions of a pair of the second forming portions may be greater than an interval between rear end portions thereof.

Meanwhile, the second forming portion may be positioned at a position between positions by quadrisecting a width of the floor panel from a side end of the floor panel and positions by trisecting the width thereof.

In addition, a width of the second forming portion may be 5 times or more and 60 times or less a thickness of the floor panel.

In addition, a height difference between the first forming portion and the second forming portion may be 10 times or more and 60 times or less a thickness of the floor panel.

In addition, a width of the second forming portion may be greater than or equal to a height difference between the first forming portion and the second forming portion and may be less than or equal to two times the height difference between the first forming portion and the second forming portion.

As another embodiment, the third forming portion may be positioned at a position between positions by dividing a width of the floor panel from a side end of the floor panel into five and positions by quadrisecting the width thereof.

As still another embodiment, a pair of fourth forming portions connected from the other side end of each of third forming portions may be formed, and the fourth forming portion may be positioned at a position between positions by dividing a width of the floor panel from a side end of the floor panel into six and positions by dividing the width thereof into five.

### BRIEF DESCRIPTION OF THE DRAWINGS

FIG. 1 is a diagram illustrating a rear floor panel applied to a vehicle.

FIG. 2 is a perspective view illustrating a rear floor panel according to one embodiment of the present disclosure.

FIG. 3 is a diagram illustrating a conventional rear floor panel and a longitudinal member based on a cross section A-A of FIG. 2.

FIG. 4 is a cross-sectional view taken along line A-A of FIG. 2.

FIG. 5 is a diagram illustrating a planar shape of the rear floor panel and transverse members of embodiments of the present disclosure.

FIG. 6 is a plane view for describing a specific forming standard of the rear floor panel of embodiments of the present disclosure.

FIG. 7 is a cross-sectional view for describing the specific forming standard of the rear floor panel of embodiments of the present disclosure.

FIGS. 8 to 10 are schematic diagrams illustrating a rear floor panel according to a modified embodiment of the present disclosure.

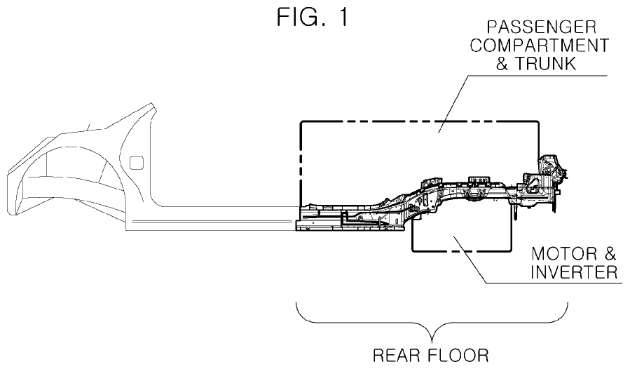

### DETAILED DESCRIPTION OF ILLUSTRATIVE EMBODIMENTS

In order to fully understand embodiments of the present disclosure and operational advantages of embodiments of the present disclosure and objects attained by practicing embodiments of the present disclosure, reference should be made to the accompanying drawings that illustrate exemplary embodiments of the present disclosure and to the description of the accompanying drawings.

In describing exemplary embodiments of the present disclosure, a description of known technologies or repeated descriptions may be reduced or omitted to avoid unnecessarily obscuring the gist of embodiments of the present disclosure.

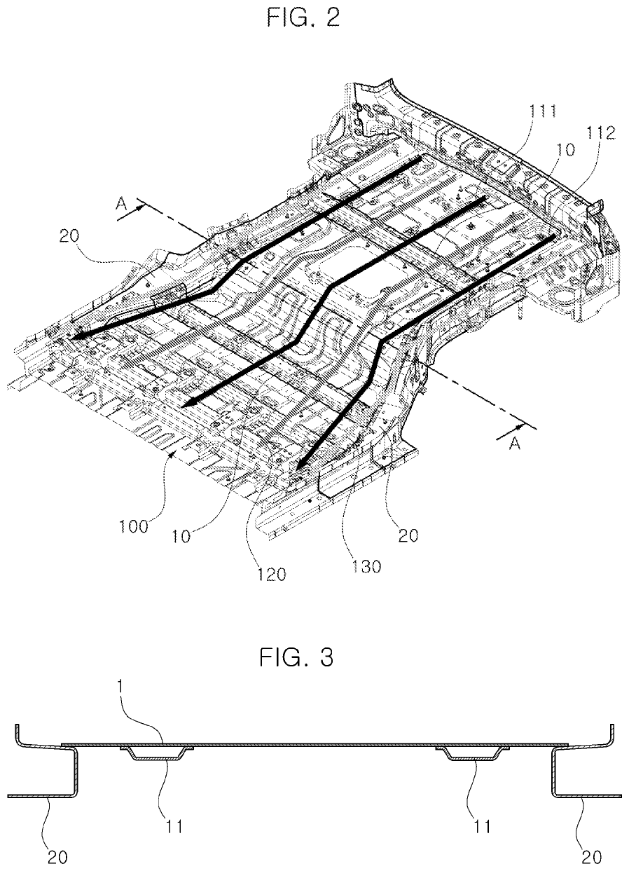

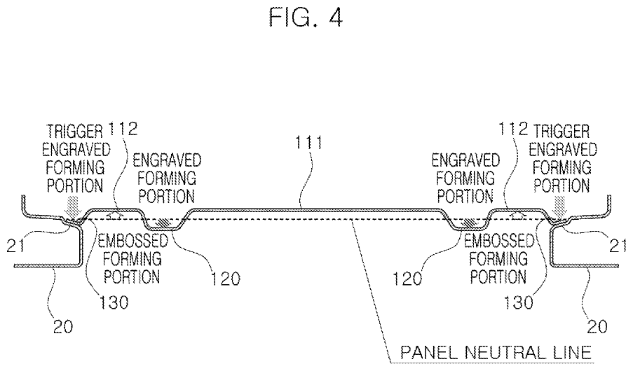

FIG. 2 is a perspective view illustrating a rear floor panel according to one embodiment of the present disclosure. FIG. 3 is a diagram illustrating a conventional rear floor panel and a longitudinal member based on a cross section A-A of FIG. 2, and FIG. 4 is a cross-sectional view taken along line A-A of FIG. 2.

Hereinafter, a rear floor panel according to one embodiment of the present disclosure will be described with reference to FIGS. 2 to 4.

Embodiments of the present disclosure relate to a floor panel, particularly, to a rear floor panel in which a transverse member, which is a main skeletal member of the rear floor panel mounted below a rear passenger compartment at a rear side of a vehicle, is maintained, and all longitudinal members 11 for rigidity of a conventional rear floor panel 1 can be deleted as shown in FIG. 3 and to a forming shape of the rear floor panel for the above purpose. A deep forming shape connected passing through each transverse member is applied to the floor panel, and the deep forming shape includes a functional relationship to achieve optimal performance according to a position of a longitudinal member, a size of a cross section, and a size of a floor section.

Both end portions of a rear floor panel 100 in a width direction are coupled to upper end portions of rear side members 20, respectively, and a plurality of transverse members 10 are coupled to a lower portion of the rear floor panel 100 at intervals.

The rear floor panel 100 of embodiments of the present disclosure, in which longitudinal members can be deleted, is formed in the form in which embossed forming portions 111 and 112, engraved forming portions 120, and trigger engraved forming portions 130 are formed.

The embossed forming portions and the engraved forming portions are alternately formed in the width direction of the rear floor panel 100 corresponding to a width direction of the vehicle, and two or more embossed forming portions and two or more engraved forming portions are formed so that static and dynamic rigidity can be increased.

In addition, the embossed forming portion and the engraved forming portion are formed in a length direction of the rear floor panel 100 corresponding to a front-rear direction of the vehicle, the embossed forming portion is formed to protrude more than the engraved forming portion, and the engraved forming portion is formed to be more depressed than the embossed forming portion.

That is, as shown in the drawings, the embossed forming portion and the engraved forming portion are formed to relatively protrude or to be depressed along a panel neutral line. The panel neutral line corresponds to an imaginary line connecting both coupling ends of the two rear side members 20.

In the drawings, an example of the rear floor panel 100 formed with the two embossed forming portions and the two engraved forming portions is shown, but three or more embossed forming portions and three or more engraved forming portions may be formed.

First, a first embossed forming portion 111 may be formed in a central portion of the rear floor panel 100 in the width direction.

Then, the engraved forming portions 120 are formed to be connected from both side ends of the first embossed forming portion 111.

Next, second embossed forming portions 112 are formed to be connected from one side end of each of the engraved forming portions 120.

That is, the first embossed forming portion 111 may be referred to as a first forming portion, the engraved forming portion 120 may be referred to as a second forming portion, and the second embossed forming portion 112 may be referred to as a third forming portion.

The first embossed forming portion 111, the second embossed forming portion 112, and the engraved forming portion 120 may have different widths, and it is preferable that the pair of second embossed forming portions 112 and the pair of engraved forming portions 120 are formed symmetrically based on the first embossed forming portion 111 of the central portion.

Alternatively, the engraved forming portion is formed in the central portion, and the embossed forming portions are connected from one end of the engraved forming portion so that the engraving and the embossing may be disposed opposite to the embodiment illustrated in FIG. 2.

The trigger engraved forming portions 130 are formed from one end of the second embossed forming portions 112, respectively, and the trigger engraved forming portions 130 are coupled to coupling ends of one side of the rear side members 20, respectively.

A joggle 21 may be formed at the coupling end of the rear side member 20 to secure coupling and connection rigidity of the trigger engraved forming portion 130 at a correct position.

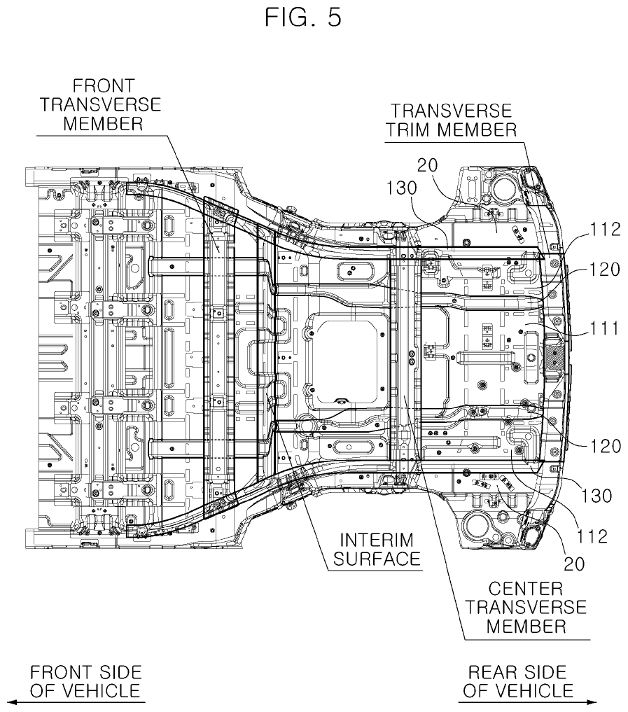

Next, FIG. 5 is a diagram illustrating a planar shape of the rear floor panel and transverse members of embodiments of the present disclosure.

All the engraved/embossed forming portions of the rear floor panel 100, from a transverse trim member of the rear end of the rear floor panel 100 to a center transverse member, an interim surface, and a front transverse member in the front-rear direction, may be connected by passing through a transverse member coupled to a lower portion of the rear floor panel 100 in the length direction of the rear floor panel 100.

Here, the forming portions may have a shape spreading outward from the transverse member at a rear end portion of the vehicle toward a front end portion thereof. That is, an interval between front end portions of the pair of symmetrical engraved forming portions 120 may be greater than an interval between rear end portions thereof.

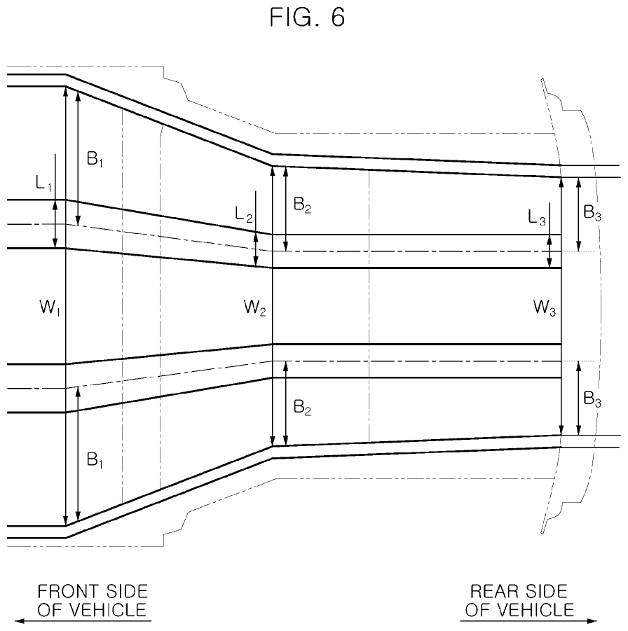

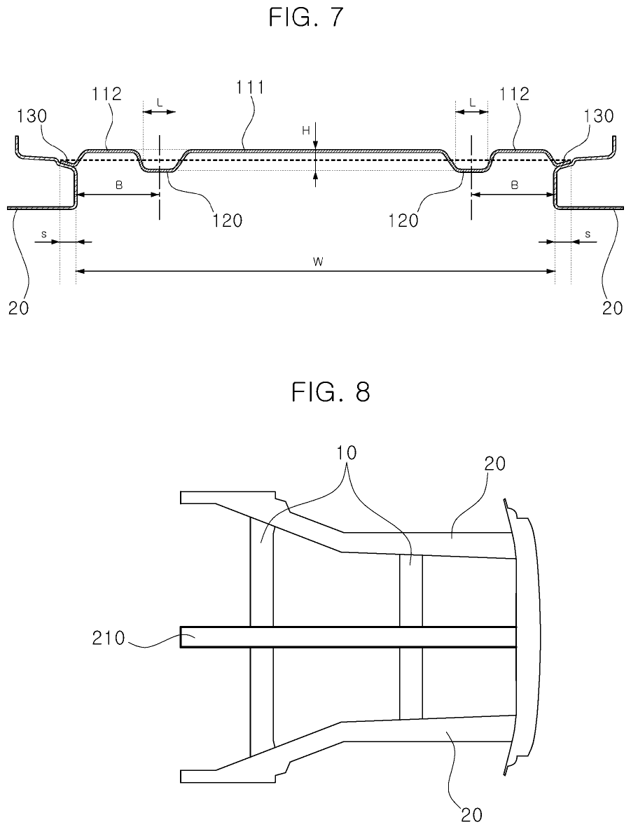

In this way, according to embodiments of the present disclosure, by changing a position and a depth of the forming portion and the number of forming portions according to a mode shape (a deformed shape of the panel when a surface load is applied) of required static and dynamic rigidity of the panel in terms of NVH, high panel rigidity can be achieved without a separate longitudinal member for securing rigidity. Hereinafter, a functional relationship between shapes and arrangements of the forming portions will be described with reference to FIGS. 6 and 7.

In the drawings, W denotes a width of the rear floor panel 100, and the width of the rear floor panel 100 may be different according to front and rear positions.

L denotes a width of the engraved forming portion 120, and H denotes a height difference between the embossed forming portion and the engraved forming portion 120, that is, a depth of the forming portion.

B denotes a length from the side end of the rear floor panel 100 to the engraved forming portion 120, that is, a position in the width direction.

t denotes a thickness of the rear floor panel 100, and s denotes a width of the trigger engraved forming portion 130.

The functional relationship is as follows.

1. Relationship between a length B from a side end of the rear floor panel 100 to the engraved forming portion 120 and a width W of the rear floor panel 100.

In the drawings, regarding a position of the forming portion in a y-axis direction, it is preferable that a forming center line is positioned at a position between trisected portions or more and quadrisected portions or less of the width of the rear floor panel 100 in the following Equation 1.

$$\frac{1}{4} \leq \frac{B}{W} \leq \frac{1}{3} \qquad Equation 1$$

2. Relationship between a width L and a depth H of the engraved forming portion 120 and a thickness t of the rear floor panel 100.

According to the non-buckling theory, the width and height of the forming portion are preferably 5 to 60 times and 10 to 60 times the thickness of the floor panel, respectively, in the following Equations 2 and 3.

$$5 \leq \frac{L}{t} \leq 60 \qquad Equation 2$$

$$10 \leq \frac{H}{t} \leq 2 \qquad Equation 3$$

3. Relationship between a width L and a depth H of the engraved forming portion 120.

The width L of the forming portion is preferably one time or more and two times or less the depth H as shown in Equation 4.

$$1 \leq \frac{L}{H} \leq 2 \qquad Equation 4$$

4. A width s of the trigger engraved forming portion 130.

The width s of the trigger engraved forming portion 130 may determine a required minimum flange according to a type of bonding (spot welding, surface plasmon resonance (SPR) welding, a flow-drill screw (FDS), arc welding, or the like) as shown in Equation 5.

$$s = 12 ∼ 20 ( Spot ) , 21 ( SPR , FDS ) , 6 ( ARC ) \qquad Equation 5$$

In the above functional relationships, the engraved forming portion and the embossed forming portion are examples, and the engraved forming portion described in the functional relationships may be the embossed forming portion.

That is, the engraved forming portion in FIGS. 6 and 7 corresponds to a forming portion extending from both side ends of the central forming portion.

Next, FIGS. 8 to 10 are schematic diagrams illustrating a rear floor panel according to a modified embodiment of the present disclosure.

In the drawings, forming portions 210, 310, and 410 may each be an embossed forming portion or an engraved forming portion, and in the description, the number of forming portions means the number of forming portions on the basis of one type of embossed or engraved forming portions.

When the number of forming portions is changed (a change in a forming pattern), a geometry of the forming portion follows Equations 2 to 5, and Equation 1 is changed in each case.

FIG. 8 shows a case in which one forming portion 210 is formed, and in this case, a relationship is as follows in Equation 6.

$$\frac{1}{2} = \frac{B}{W} \qquad Equation 6$$

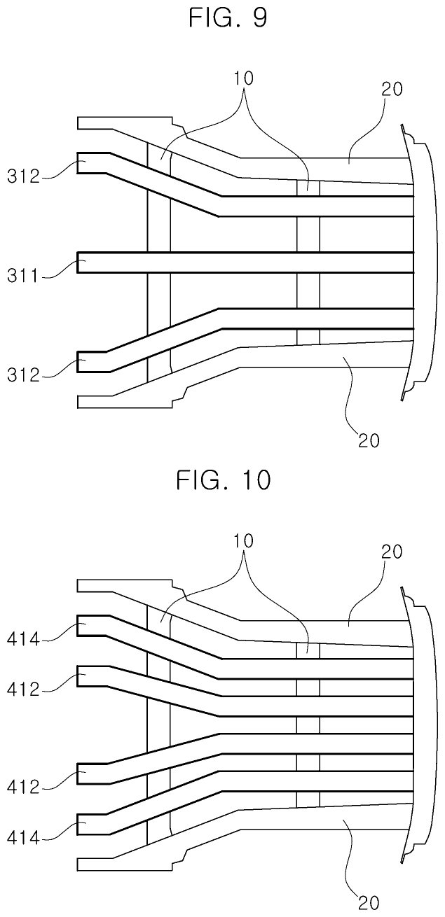

FIG. 9 shows a case in which three forming portions are formed, second and third forming portions 312 are formed based on a first forming portion 311 at the center, and a length B from a side end of the rear floor panel to the third forming portion 312 is changed as follows in Equation 7.

$$\frac{1}{4} \leq \frac{B}{W} \leq \frac{1}{5} \qquad Equation 7$$

FIG. 10 shows a case in which four forming portions are formed, second forming portions 412 and third and fourth forming portions 414 are formed based on a first forming portion at the center, and a length B from a side end of the rear floor panel to the fourth forming portion 414 is changed as follows in Equation 8.

$$\frac{1}{5} \leq \frac{B}{W} \leq \frac{1}{6} \qquad Equation 8$$

As described above, when compared to the existing structure, according to the rear floor panel of embodiments of the present disclosure, a weight, costs, the number of welds, and the number of parts can be reduced by omitting longitudinal members, and an increase of marketability due to an increase of static & dynamic rigidity of a panel (road noise reduction and power element (PE) room radiation transmission noise reduction) can be expected.

When compared to the existing structure, according to a floor panel of embodiments of the present disclosure, a weight, costs, the number of welds, and the number of parts can be reduced by omitting longitudinal members.

In addition, it is possible to apply an optimal forming shape to a configuration design area (in consideration of a layout) and a panel thickness.

Therefore, an increase of marketability due to an increase of static and dynamic rigidity of a panel (road noise reduction and power element (PE) room radiation transmission noise reduction) can be expected.

In addition, when it is necessary to set a longitudinal member for securing panel rigidity, a structure can be simplified by applying a structure according to embodiments of the present disclosure.

While embodiments of the present disclosure have been described with reference to the accompanying drawings, it will be apparent to those skilled in the art that various changes and modifications can be made without departing from the spirit and scope of embodiments of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A floor panel comprising:
an embossed forming portion extending in a length direction of the floor panel; and
an engraved forming portion extending in the length direction of the floor panel, wherein the embossed forming portion and the engraved forming portion are alternately disposed in a width direction of the floor panel.

2. The floor panel of claim 1, wherein:
the embossed forming portion protrudes above an imaginary panel neutral line connecting both side ends of the floor panel; and
the engraved forming portion protrudes below the imaginary panel neutral line.

3. The floor panel of claim 1, wherein the embossed forming portion and the engraved forming portion each comprise a plurality of portions.

4. A floor panel comprising:
a first forming portion extending in a length direction of the floor panel, the first forming portion being disposed in a central portion of the floor panel in a width direction of the floor panel; and
second forming portions extending in the length direction of the floor panel, the second forming portions being connected at side ends of the first forming portion, respectively; and
wherein the first forming portion is either an embossed forming portion or an engraved forming portion and the second forming portions are the other of the embossed forming portion or the engraved forming portion.

5. The floor panel of claim 4, wherein the second forming portions are symmetrically disposed based on the first forming portion.

6. The floor panel of claim 4, further comprising a pair of third forming portions connected at outer side ends of the second forming portions, respectively.

7. The floor panel of claim 6, wherein each of the pair of third forming portions is disposed at a position between first positions obtained by dividing a width of the floor panel from a side end of the floor panel by five and second positions obtained by quadrisecting the width thereof.

8. The floor panel of claim 6, further comprising a pair of fourth forming portions connected at outer side ends of the third forming portions, respectively, wherein each of the pair of fourth forming portions is disposed at a position between first positions obtained by dividing a width of the floor panel from a side end of the floor panel by six and second positions obtained by dividing the width thereof by five.

9. The floor panel of claim 4, wherein the floor panel comprises a rear floor panel configured to be mounted below a rear passenger compartment of a vehicle, and wherein both end portions of the rear floor panel are configured to be coupled to a pair of rear side members of the vehicle, respectively.

10. The floor panel of claim 9, further comprising a pair of trigger forming portions at both ends of the rear floor panel in the width direction, respectively, wherein the pair of trigger forming portions are configured to be coupled to the pair of rear side members, respectively.

11. The floor panel of claim 10, further comprising a pair of joggles at the pair of rear side members, respectively, wherein the pair of trigger forming portions is coupled to the pair of joggles, respectively.

12. The floor panel of claim 4, wherein an interval between front end portions of a pair of the second forming portions is greater than an interval between rear end portions thereof.

13. The floor panel of claim 4, wherein each of the second forming portions is disposed at a position between first positions obtained by quadrisecting a width of the floor panel from a side end of the floor panel and second positions obtained by trisecting the width thereof.

14. The floor panel of claim 4, wherein a width of each of the second forming portions is 5 times to 60 times a thickness of the floor panel.

15. The floor panel of claim 4, wherein a height difference between the first forming portion and each of the second forming portions is 10 times to 60 times a thickness of the floor panel.

16. The floor panel of claim 4, wherein a width of each of the second forming portions is greater than or equal to a height difference between the first forming portion and the respective second forming portion and is less than or equal to two times the height difference between the first forming portion and the respective second forming portion.

17. A vehicle comprising:
a vehicle body comprising a pair of rear side members on each side of the vehicle body and extending in a longitudinal direction of the vehicle body; and
a rear floor panel coupled to the pair of rear side members at each side of the rear floor panel, respectively, wherein the rear floor panel comprises:
a first forming portion disposed in a central portion of the rear floor panel in a width direction of the rear floor panel;
a pair of second forming portions connected at both side ends of the first forming portion, respectively; and
a pair of third forming portions connected at outer side ends of the pair of second forming portions; and
wherein the first forming portion and the pair of third forming portions are either embossed forming portions or engraved forming portions and the pair of second forming portions are the other of the embossed forming portions or the engraved forming portions.

18. The vehicle of claim 17, further comprising:
a pair of joggles coupled to the pair of rear side members, respectively; and
a pair of trigger forming portions at outer ends of rear floor panel in the width direction of the rear floor panel, wherein the pair of trigger forming portions is coupled to the pair of joggles, respectively.

19. The vehicle of claim 17, wherein an interval between front end portions of the pair of second forming portions is greater than an interval between rear end portions thereof.

20. The vehicle of claim 17, wherein:
a width of each of the pair of second forming portions is 5 times to 60 times a thickness of the rear floor panel; and
a height difference between the first forming portion and each of the pair of second forming portions is 10 times to 60 times the thickness of the rear floor panel.
